(19) United States
(12) Patent Application Publication
(10) Pub. No.: US 2013/0057380 A1
(43) Pub. Date: Mar. 7, 2013

(54) PROTECTION DEVICE FOR CIRCUIT

(71) Applicant: Tsung-Mou Yu, New Taipei City (TW)

(72) Inventor: Tsung-Mou Yu, New Taipei City (TW)

(21) Appl. No.: 13/227,467

(22) Filed: Sep. 7, 2011

(51) Int. Cl. H01H 71/20

(52) U.S. Cl. 337/219

(57) ABSTRACT

A protection device for a circuit includes a case and a breaker unit received in the case. The case has two sets of wires and each wire has two wire ends connected to the case. The breaker unit has at least one meltable member, at least two first resilient members, at least two conductive members and at least two second resilient members. When overload or overheat, the meltable member of the breaker unit reaches a pre-set temperature and melts and breaks to become debris. The conductive members are separated from the two wire ends to cut off the circuit.

### BACKGROUND OF THE INVENTION

1. Field of the Invention

The present invention relates generally to a temperature sensitive protection device for a circuit and the device includes a meltable member which is melted and broken in the overload or overheat status to permanently cut off the circuit.

2. The Prior Arts

A conventional circuit has a switch which is normally set to be ON and a fuse device or a breaker is connected to the switch. When the circuit is in the status of overload, overheat or short, the fuse device or the breaker is activated to cut off the circuit to protect the circuit.

For some high-priced electronic appliances or electronic products, such as the data processing unit or the heater that requires higher electric power, the temperature sensitive protection device is installed to the circuit or the individual appliance. Thus, when the circuit is overload, overheat or short, the temperature sensitive protection device cuts off the circuit to protect the electronic appliance. Also the problem of the individual circuit does not affect the operation of the whole circuits in the appliances or electronic products.

Referring to FIGS. 1A and 1B, a conventional temperature sensitive protection device for a circuit includes a meltable member 503 connected between the first wire end 501 and the second wire end 502 so as to form the circuit as shown in FIG. 1A. The meltable member 503 is made of an alloy. A resin 504 is mounted to cover the meltable member 503 and an insulation material 505 is mounted to cover the resin 503. The open ends of the first wire end 501 and the second wire end 502 are sealed by a sealing material 506. In case of overload or overheat, the meltable member 503 is melted and broken into debris 503′ as shown in FIG. 1B. Due to the cohesive force of the alloy, the debris 503′ is held together at the first wire end 501 and the second wire end 502. Therefore, the first wire end 501 and the second wire end 502 are not in contact with each other to form the OFF status to protect the appliance or electronic product.

The shortcomings of the temperature sensitive protection device mentioned above are that the protection device can only be connected with one wire and which is not suitable for protecting precise appliances or equipments. Furthermore, if two wires respectively need circuit protection, it needs two temperature sensitive protection devices, which increases the cost.

FIGS. 2A and 2B show another conventional temperature sensitive protection device for a circuit. A first wire end 601 is connected to a metal case 603 and the metal case 603 is connected with the second wire end 602 via a conductive plate 604 to form the circuit, as shown in FIG. 2A. When overload or the temperature is too high, the temperature sensitive particle 605 is melted and broken to be debris 605′. The first and second springs 606, 607 extend due to the broken breakable particle 605. The second spring 607 pushes the conductive plate 604 to the left. Thus, the conductive plate 604 is separated from the second wire end 602 as shown in FIG. 2B. The conductive plate 604 and the second wire end 602 are not in contact with each other to cut off the circuit.

The shortcomings of the temperature sensitive protection device mentioned above are that the metal case 603 is part of the circuit and exposed to the environment. Thus, the metal case 603 may be in contact with other metal parts to short the circuit. Again, the protection device can only be connected with one wire and which is not suitable for protecting precise appliances or equipments. Furthermore, if the two wires respectively need circuit protection, it needs two temperature sensitive protection devices, which increases the cost.

### SUMMARY OF THE INVENTION

A primary objective of the present invention is to provide a protection device for a circuit, which overcomes the shortcomings of the conventional designs that does not cut off the circuit completely, causes short circuit, can only protect one wire, responds not sensitive enough and is not suitable for protecting precise appliances.

In order to achieve the objective, a protection device according to the present invention has a case and a breaker unit. The case has two sets of wires and each set of wire includes two wire ends connected with the case. The breaker unit is received in the case. The breaker unit includes at least one meltable member, at least two first resilient members, at least two conductive members and at least two second resilient members. Two ends of the meltable member are respectively biased by the two first resilient members and the two first resilient members respectively push the two conductive members outward. Each of the conductive members is pushed to contact with one set of wire and electrically connect the two wire ends to form a circuit. The two conductive members respectively contact with the two second resilient member which are compressed to generate restoring forces to bias the conductive members. When overload or overheat, the meltable member of the breaker unit melts and breaks to become debris. At least one of the conductive members is pushed by the second resilient member and separated from the two wire ends to cut off the circuit.

One of the advantages of the present invention is that the protection device cuts off the circuit permanently, which improves the safety of the circuit. Another advantage of the present invention is that the protection device only needs one of the conductive members separated from the corresponding wire ends to cut off the circuit, which improve the sensitivity of the device.

### BRIEF DESCRIPTION OF THE DRAWINGS

The present invention will be apparent to those skilled in the art by reading the following detailed description of a preferred embodiment thereof, with reference to the attached drawings, in which:

FIG. 1A is a cross sectional view to show a conventional protection device in the ON status;

FIG. 1B is a cross sectional view to show the conventional protection device in the OFF status;

FIG. 2A is a cross sectional view to show another conventional protection device in the ON status;

FIG. 2B is a cross sectional view to show the conventional protection device of FIG. 2A in the OFF status;

FIG. 3 is an exploded view to show a protection device according to the present invention;

FIG. 4 is a cross sectional view to show the protection device according to the present invention in the ON status; and

FIG. 5 is a cross sectional view to show that a meltable member of a breaker unit according to the present invention melts and breaks to become debris and the circuit is in the OFF status.

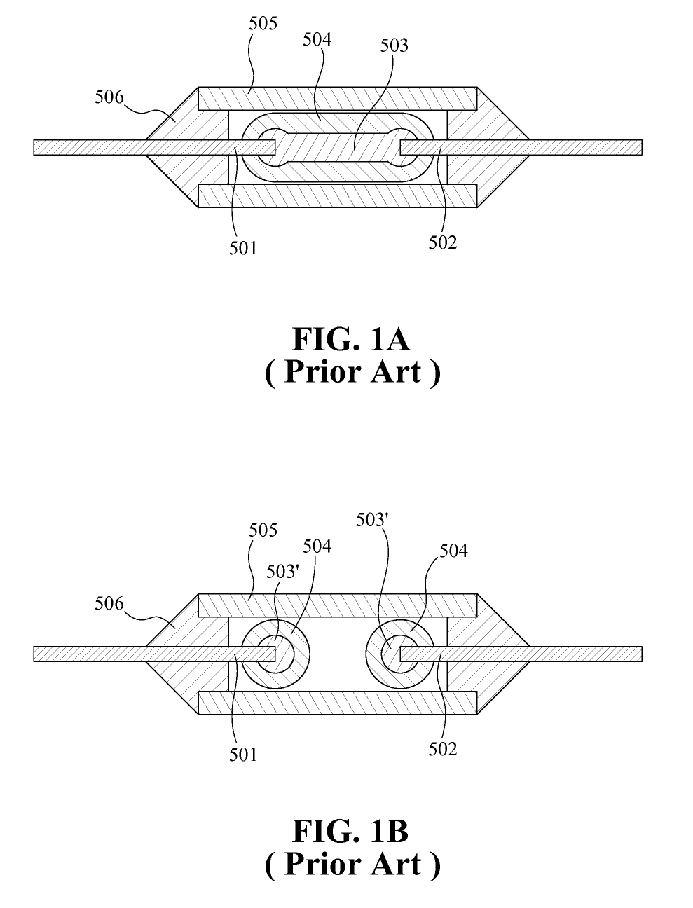

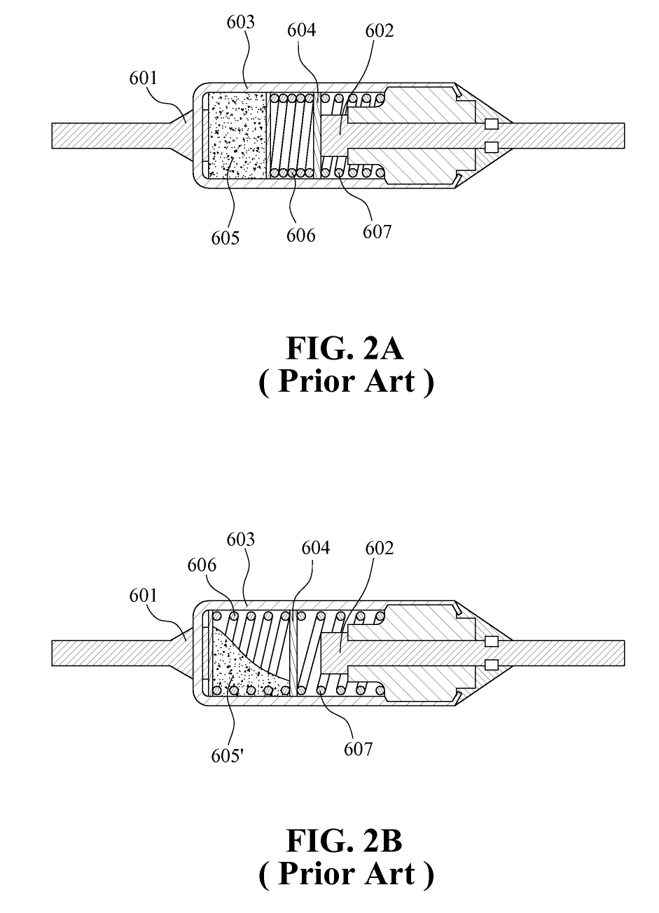

### DETAILED DESCRIPTION OF THE PREFERRED EMBODIMENT

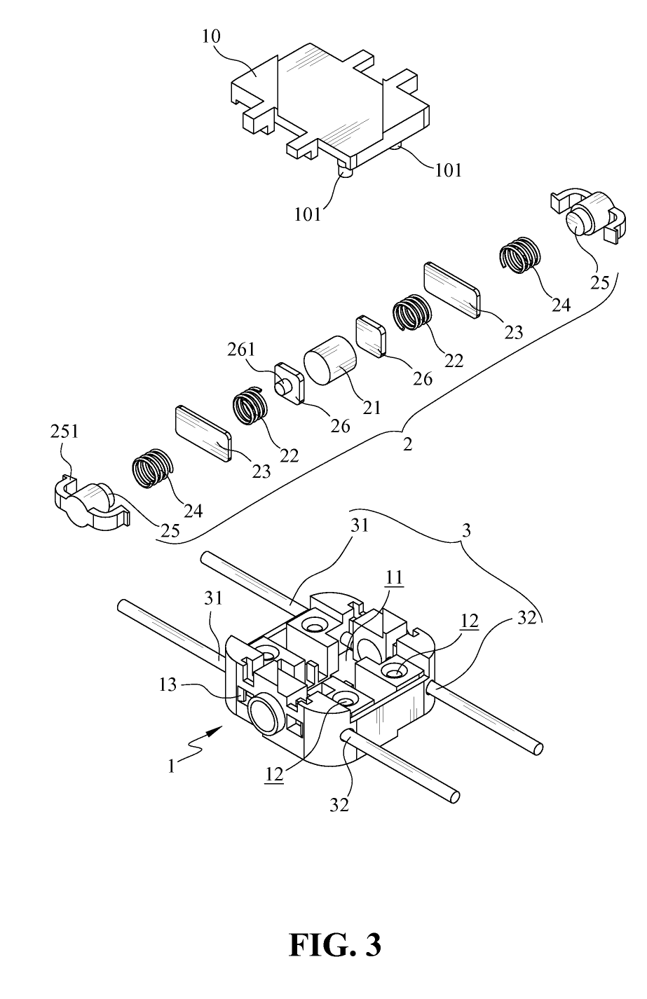

With reference to FIGS. 3 to 5, a protection device for a circuit in accordance with the present invention comprises a case 1 and a breaker unit 2.

The case 1 is made of an insulation material and has two sets of wires 3. Each set of wires 3 includes two wire ends 31, 32 connected to the case 1. There is a gap between the wire ends 31, 32. A slot 11 is defined in the case 1 and the breaker unit 2 is received in the slot 11. The case 1 has at least one connection hole 12 and a cover 10 includes at least one connection rod 101 corresponding to the connection hole 12. When the cover 10 is mounted to the opening of the case 1, the connection rod 101 of the cover 10 is engaged with the connection hole 12 of the case 1.

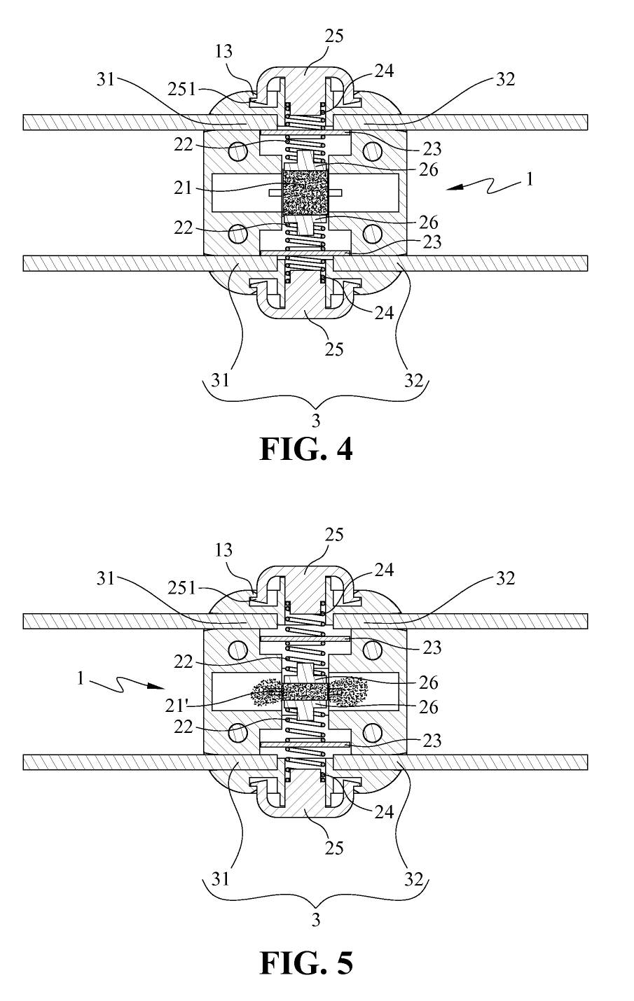

The breaker unit 2 has at least one meltable member 21, at least two first resilient members 22, at least two conductive members 23 and at least two second resilient members 24. Referring to FIG. 4, the meltable member 21 is disposed between the two first resilient members 22. The meltable member 21 and the first resilient members 22 are disposed between the two conductive members 23. The meltable member 21, the first resilient members 22 and the conductive members 23 are disposed between the two second resilient member 24. Two ends of the meltable member 21 are respectively biased by the two first resilient members 22. The first resilient members 22 respectively push the two conductive members 23 outward so that each of the conductive members 23 are in contact with one set of wire 3. Thus, the conductive member 23 electrically connects the wire ends 31, 32 to form a circuit. The two conductive members 23 are respectively contacted with the two second resilient member 24 which are compressed to generate two restoring forces to bias the two conductive members 23.

According to this embodiment, the meltable member 21 of the breaker unit 2 is an alloy which easily melts and breaks to become debris at predetermined temperature. The meltable member 21 of the breaker unit 2 can also be a temperature sensitive particle which easily melts and breaks at pre-set temperature to become debris.

When overload or overheat, the temperature of the meltable member 21 of the breaker unit 2 continues goes high and reaches a pre-set temperature, the meltable member 21 melts and breaks to become debris 21′ which occupies less space than the meltable member 21. Referring to FIG. 5, after the meltable member 21 is melted, the two first resilient members 22 lost the biasing force from the meltable member 21 so that the two conductive members 23 are pushed by the force of the second resilient members 24. The two conductive members 23 are separated from the two wire ends 31, 32 to cut off the circuit. The circuit is permanently cut off to protect the appliance.

Of course, it is possible that only one conductive member 23 is separated from the two wire ends 31, 32 when the meltable member melts and breaks. In this situation, the circuit is cut off as well. In other words, the protection device according to the present invention only needs one of the conductive members 23 separated from the corresponding wire ends 31, 32 to cut off the circuit.

Referring to FIG. 3, an insulation member 26 is located between the meltable member 21 and the first resilient member 22 to provide insulation between the two sets of wires (i.e. an earth wire and a live wire) 3. The insulation member 26 is a board-like member and has a rod 261 which is inserted into the first resilient member 22 so that the first resilient member 22 can only be compressed or stretched axially. Furthermore, a locking member 25 is disposed at an outside of the second resilient member 24 and is inserted into the second resilient member 24 so that the second resilient member 24 can only be compressed or stretched axially. The two locking members 25 have hooks 251 which are engaged with tabs 13 of the case 1. The locking members 25 push the second resilient members 24 which store restoring forces to bias the conductive members 23.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A protection device for a circuit, comprising:
a case made of an insulation material and having a slot defined in the case and two sets of wires, each set of the wire including two wire ends connected to the case; and
a breaker unit received in the slot of the case and having at least one meltable member, at least two first resilient members, at least two conductive members and at least two second resilient members, the meltable member biased by the two first resilient members which push the two conductive members outward, each of the conductive members pushed to be contacted with the two wire ends to form a circuit, the two conductive members respectively contacted with the two second resilient member which are compressed to generate restoring forces to bias the two conductive members;
wherein when overload or overheat, the meltable member of the breaker unit melts and breaks to form debris, at least one of the conductive members is pushed by the second resilient member and separated from the two wire ends to cut off the circuit.

2. The protection device as claimed in claim 1, wherein an insulation member is disposed between the meltable member and the first resilient member, the insulation member insulates the two sets of wires from each other.

3. The protection device as claimed in claim 2, wherein the insulation member is a board-like member and has a rod which is inserted into the first resilient member so that the first resilient member is compressed or stretched axially.

4. The protection device as claimed in claim 1, wherein a locking member is disposed at an outside of the second resilient member and is inserted into the second resilient member so that the second resilient member is compressed or stretched axially, the locking member pushes the second resilient member which stores a force to bias the conductive member.

5. The protection device as claimed in claim 1, wherein the meltable member is an alloy which melts and breaks into debris when a predetermined temperature is reached.

6. The protection device as claimed in claim 1, wherein the meltable member is a temperature sensitive particle which melts and breaks into debris when a predetermined temperature is reached.
